(19) United States
(12) Patent Application Publication
(10) Pub. No.: US 2016/0074780 A1
(43) Pub. Date: Mar. 17, 2016

(54) APPARATUS AND METHOD FOR DEWATERING FLOCCULATED SLURRIES

(71) Applicant: Genesis Water, Inc., Centennial, CO (US)

(72) Inventors: Matthew Herman, Monument, CO (US); Michael Hodges, Monumet, CO (US); Jan Dekker, Centennial, CO (US)

(21) Appl. No.: 14/850,420

(22) Filed: Sep. 10, 2015

Related U.S. Application Data
(60) Provisional application No. 62/049,162, filed on Sep. 11, 2014.

(51) Int. Cl. B01D 33/03; B01D 33/72

(52) U.S. Cl. CPC B01D 33/0361; B01D 33/72

(57) ABSTRACT

The embodiments relate to systems and methods for dewatering a flocculated slurry. A flow of slurry is received, the slurry comprising a liquid and solid particulate that is suspended in the liquid. At least a portion of the solid particulate is flocculated to form the flocculated slurry comprising flocculated material in the liquid. The flow of the flocculated slurry is delivered to a tracking screen that is configured to separate the flocculated material from the liquid. While the flow of flocculated slurry is disposed relative to the tracking screen, a pulse of energy is delivered to the tracking screen.

### CROSS-REFERENCE TO RELATED APPLICATION

This application is a nonprovisional patent application of and claims the benefit of U.S. Provisional Patent Application No. 62/049,162 filed Sep. 11, 2014 and titled “Apparatus and Method For Dewatering Flocculated Slurries,” the disclosure of which is hereby incorporated herein by reference in its entirety.

### TECHNICAL FIELD

The present disclosure generally relates to dewatering a slurry and, more specifically, to dewatering a flocculated slurry using energy pulses created using a percussion mechanism

### BACKGROUND

A byproduct of traditional dredging, mining, and paper operations may include liquid waste in the form of a slurry or sludge which include fine particulates and other solids in suspension or otherwise mixed with water. Treatment and reclamation of water and the suspended solids may be vital to ensure productive, compliant, and sustainable operations. However, separating water from such solids and fine particulate material may be challenging on an industrial scale, particularly for operations that are continuous or ongoing in nature. Some traditional treatment techniques involve holding the slurry or sludge in a settling basin, settling pond, or lagoon for an extended period of time to allow the solids to settle or the water to evaporate. Other techniques for separating fine material from water may be expensive and time consuming. Processing rates may be relatively slow, resulting in costly operations. Thus, such traditional techniques may be impractical or insufficient for some industrial applications, including large scale dredging, mine tailing treatment, and other large-scale industrial operations.

Thus, there is a need for slurry processing techniques that can accommodate the production demands of large-scale industrial and dredging operations. The system and techniques described herein can be used to remove fine particles or liquid from a slurry without some of the drawbacks associated with some traditional techniques.

### SUMMARY

The embodiments described herein relate to methods for dewatering a flocculated slurry. In some embodiments, a flow of slurry is received, the slurry comprising a liquid and solid particulate that is suspended in the liquid. At least a portion of the solid particulate is flocculated to form a flocculated slurry. A flow of the flocculated slurry is delivered to a tracking screen that is configured to separate at least a portion of the flocculated material from the liquid. While the flow of flocculated slurry is disposed relative to the tracking screen, a pulse of energy is delivered to the tracking screen. The pulse of energy may release water trapped in the screen and facilitate the free drainage of the liquid from the slurry.

In some embodiments, the pulse of energy is produced using a percussion mechanism that is operatively coupled to the tracking screen. In some embodiments, the percussion mechanism produces the pulse of energy by displacing the tracking screen in a direction that is transverse to the flow. The energy produced by the percussion mechanism may form a drainage zone over an area that is less than the total area of the tracking screen. Thus, in some cases, multiple percussion mechanisms are disposed relative to the tracking screen to create multiple, partially overlapping drainage zones. In some embodiments, the percussion mechanism produces the pulse of energy by displacing the tracking screen in a direction that is substantially in plane with or parallel to a plane of the flow.

In some embodiments, the pulse of energy causes a disruption in a film of liquid formed on a surface of the tracking screen. The pulse of energy may break the film or otherwise release the liquid from the tracking screen. The pulse of energy may also cause a shift or movement within a mass of flocculated material to release water held on the surface of the flocs. In some cases, the pulse of energy does not significantly degrade, deteriorate, or collapse the floc structures of the flocculated material.

Some example embodiments are directed to method for dewatering a flocculated slurry. A flow of slurry comprising a liquid and solid particulate that is suspended in the liquid may be received. At least a portion of the solid particulate may be flocculated to form the flocculated slurry comprising flocculated material and the liquid. A flow of the flocculated slurry may be delivered to a tracking screen configured to separate the flocculated material from the liquid. While the flow of flocculated slurry is disposed relative to the tracking screen, a pulse of energy may be delivered to the tracking screen.

In some embodiments, the pulse of energy is produced using a percussion mechanism that is operatively coupled to the tracking screen. The percussion mechanism may be used to deliver a series of energy pulses at a rate greater than 5 pulses per minute and less than 120 pulses per minute. In some cases, the series of energy pulses includes a rest period between energy pulses in which substantially no energy is delivered to the tracking screen by the percussion mechanism.

In some embodiments, the pulse of energy is delivered to the flow of flocculated slurry via the tracking screen to produce a drainage zone that corresponds to a portion of the tracking screen having improved liquid drainage. In some cases, a first pulse of energy is produced using a first percussion mechanism that is operatively coupled to the tracking screen resulting in a first drainage zone. A second pulse of energy may be produced using a second percussion mechanism that is operative coupled to the tracking screen resulting in a second drainage zone. The first drainage zone and the second drainage zone may be partially overlapping. In some implementations, the first pulse of energy and the second pulse of energy are delivered to the tracking screen at different times.

The first pulse of energy may be produced using a first percussion mechanism that is operatively coupled to the tracking screen resulting in a first drainage zone and the second pulse of energy may be produced using a second percussion mechanism that is operative coupled to the tracking screen resulting in a second drainage zone. The first pulse of energy and the second pulse of energy are delivered to the tracking screen at different times. A third pulse of energy may be produced using a third percussion mechanism that is operative coupled to the tracking screen resulting in a third drainage zone.

In some embodiments, the pulse of energy causes a disruption in a film of liquid formed on a surface of the tracking screen resulting in an increase of a flow of liquid through the tracking screen. In some cases, the pulse of energy does not substantially degrade floc structures of the flocculated material.

In some embodiments, liquid that passes through the tracking screen is collected and distributed. The liquid may have a substantial amount of flocculated solids removed by the tracking screen. A mass of substantially dewatered solids may be produced on a top surface of the tracking screen. The dewatered solids may be removed from the top surface of the tracking screen. For example, the dewatered solids may be mechanically scraped and/or driven from the top surface and transported to another station for further processing or disposal.

Some example embodiments are directed to a method for dewatering a flocculated slurry that includes: receiving a flow of flocculated slurry comprising flocculated solids in a liquid; delivering the flow of the flocculated slurry to a tracking screen configured to separate the flocculated solids from the liquid; and while the flow of flocculated slurry is disposed relative to the tracking screen, delivering a pulse of energy to the tracking screen. In some cases, the pulse of energy is produced using a percussion mechanism that displaces the tracking screen in a direction that is transverse to the flow. In some cases, the pulse of energy is produced using a percussion mechanism that displaces the tracking screen in a direction that is substantially parallel with a plane of the flow. Before delivering the flow of the flocculated slurry to the tracking screen, the flocculated slurry may be elevated using a riser duct, wherein a gas is delivered to the riser duct to produce a substantially even distribution of gas bubbles that reduces a precipitation of solids in the flocculated slurry.

Some example embodiments are directed to a tracking screen assembly. The assembly may include a riser duct that is configured to receive a flow of flocculated slurry comprising a flocculated solid in a liquid. The assembly may also include an outlet that is coupled to the riser duct. The outlet may be configured to distribute the flocculated slurry over a tracking screen. The tracking screen may be disposed below the outlet and configured to separate the flocculated solid from the liquid. A percussion mechanism may be operably coupled to the tracking screen and configured to produce an energy pulse to the flow of slurry while the flow of slurry is disposed relative to a surface of the tracking screen.

In some embodiments, the tracking screen is positioned at an incline angle and is configured to separate the flocculated solid from the liquid as the flocculated slurry is fed by gravity. The riser duct may be configured to deliver a substantially even distribution of gas bubbles into the flocculated slurry. The riser duct may be operatively coupled to a dredge assembly that is configured to collect solids from a body of water. The riser duct may be operatively coupled to a flocculating system that is configured to flocculate solids that are suspended in the liquid of the slurry.

### BRIEF DESCRIPTION OF THE DRAWINGS

FIG. 1 depicts an example system for collecting and dewatering a slurry.

FIG. 2 depicts a perspective view of an example tracking screen assembly.

FIG. 3 depicts a cross-sectional view of an example tracking screen assembly having multiple percussion mechanisms taken along section A-A of FIG. 2.

FIG. 4 depicts an example tracking screen operably connected to multiple percussion mechanisms to produce multiple, partially overlapping drainage zones.

FIG. 5 depicts an example tracking screen having a percussion mechanism configured to actuate in a direction that is substantially parallel to the plane of the flow.

FIG. 6 depicts an example tracking screen operably connected to multiple percussion mechanisms to produce multiple, partially overlapping drainage zones.

FIG. 7 depicts an example process for separating flocculated solids from a slurry.

### DETAILED DESCRIPTION

The system and techniques described herein can be used as part of a sustainable dewatering and solid retrieval system that is especially adapted for various scale operations. In particular, the system and techniques of the present disclosure may be suitable for use with waterway dredging operations, mine tailing treatment processes, and other industrial fluid treatment applications. The system and techniques described herein can be implemented as part of a comprehensive water treatment operation and can reduce the cost of large waterway projects by facilitating high-speed solids separation, including fine grained material, such as clays, silts, and organics. In some implementations, the water treatment operation can be used to recover solids in real time, producing sand, gravel, and soil that are ready for transport, while releasing large volumes of clear water instantly for reuse or return to waterway. The techniques may also be suitable for managing tailings for the mining industry as part of a sustainable and continuous treatment operations. In some cases, the techniques can be used as part of a system adapted quickly release the hydraulic load from slurries or tailings pond clean-ups.

In general, hydraulic dredges are effective excavation devices for removing a wide variety of sediments from natural or manmade waterways. A dredge may remove sediments which are classified as contaminated or hazardous sediments as well as non-hazardous sediments. The sediments may comprise debris such as sand, gravel, clays, silts, organic matter, or any combination thereof. Typically, the finest or smallest particle solids, including clays, silts, and organic matter, contributes the greatest volume of the dredged solids and is also the most difficult to recover. In some applications, all or nearly all of the materials excavated from a waterway as part of a hydraulic dredging process must be removed to a disposal site. Traditionally, these sites include settling ponds or basins that are specifically engineered to accommodate the slow settling characteristics of the finest of the particulate matter. Using traditional techniques, the extracted solids are dewatered primarily by evaporating off the liquid over time. However, large-scale settling ponds may burden the immediate community in various ways. Large ponds may occupy significant areas of land and may also emit noxious odors and attract insect pests over the course of a long solid-settling process.

The system and techniques of the present disclosure can be used to rapidly remove fine particulate matter from a slurry. In particular, aspects of the present disclosure include introduction of a flocculating agent that can be used to form flocs or flocculated material from fine solid particulate that are suspended in the slurry. In some implementations, the flocculated material within the slurry is delivered to a tracking screen that separates the flocculated solids from the water or liquid. In particular, as the flocculated slurry passes over the tracking screen, water is allowed to drain through the apertures of the screen mesh media and into a liquid retrieval system located below the screen. The flocculated solids remain on the upper surface of the screen, where they can be removed by a gravity feed or other transport mechanism.

However, in some cases, the surface tension of the water may result in the formation of a film or distribution of water within the screen mesh media that inhibits the effective transport of water through the media. In some cases, the apertures of the screen mesh media can also become blocked by the flocculated material, thereby inhibiting the drainage of water through the tracking screen. Additionally, water may become trapped between the flocs of the slurry, which may also inhibit efficient water separation.

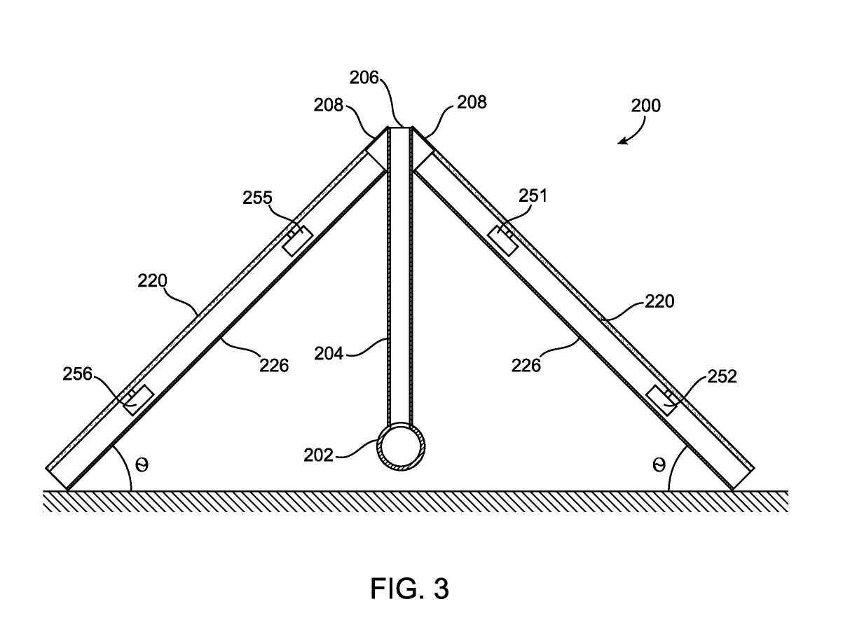

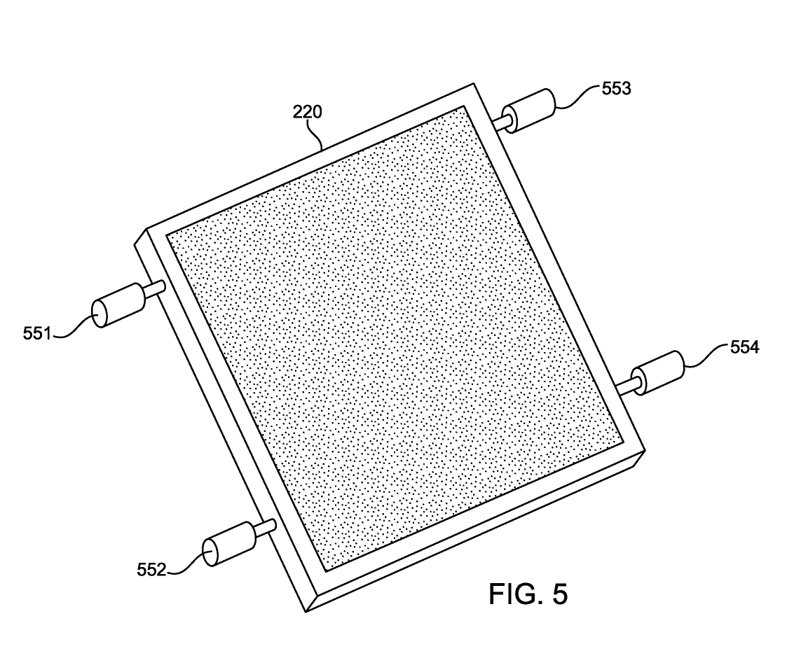

Therefore, in some implementations, an energy pulse is transmitted through the slurry and the screen mesh media to facilitate efficient and reliable operation of the tracking screen. In some implementations, the propagation of an energy pulse is sufficient to disrupt the surface tension of the water, but does not destroy, degrade, or otherwise break down the floc structures of the sold materials. As described in more detail below with respect to FIGS. 3 and 5, a percussion mechanism may be used to produce an energy pulse or series of energy pulses through the screen mesh media and the slurry to significantly improve a dewatering process.

The flocculation and dewatering of a slurry may be incorporated into or used in conjunction with a sludge collection and treatment operation. While the following discussion is provided with respect to a dredging operation, the techniques of the present disclosure may also be used to process a liquid having suspended solids resulting from a variety of application, including, for example, water reclamation operations, mine tailing processing, oil sand processing, and other applications. The following example provided with respect to a dredging operation is illustrative in nature and not intended to be limiting in nature.

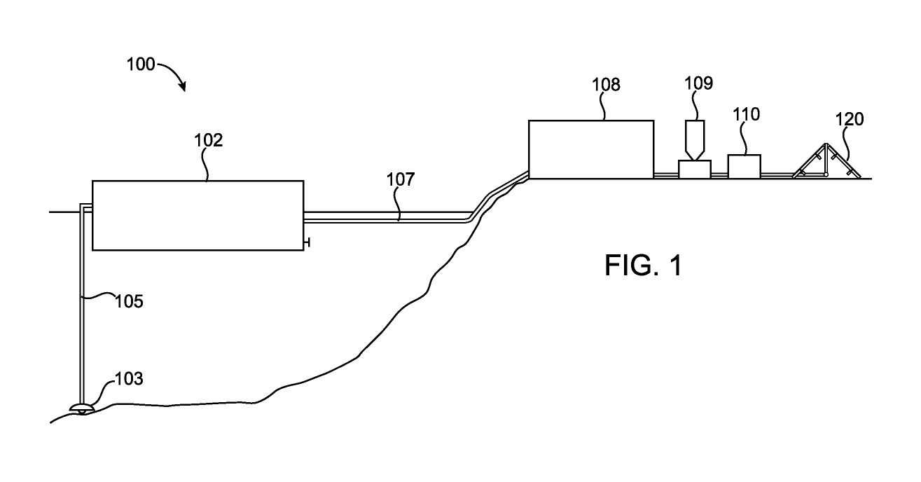

FIG. 1 depicts an example system 100 for collecting and procession solids and water collected as part of a dredging operation. As shown in FIG. 1, a dredge assembly 102 can be used to collect solids and sediments located under a body of water. In this example, the dredge assembly 102 includes a cutting head 103 for dislodging sediment, a suction line 105 for removal of the dislodged settlements. The dredge assembly 102 may optionally include a barge or other floating vehicle for accessing the sediments. In some implementations, the dredge assembly 102 is fixed or is operated from a structure that is attached to the ground or a dock. The dredge assembly 102 may include, for example, a hydraulic dredge (as depicted in FIG. 1), a mechanical dredge, and/or other type of dredge for extracting sediment from a body of water.

As shown in FIG. 1, a slurry pipe line 107 may be used to transport dredged slurry to other elements of the system 100. In this example, the system 100 includes a first separator 108 that is configured to receive the stream of slurry and to separate objects larger than a first size. In some embodiments, the first separator 108 is configured to remove large objects, including, for example shells, rocks, plastic shopping bags, metal pieces, batteries, woodchips, pieces of wire and fishing line, vegetation, delaminated carpet, artificial grass and other objects that may be excavated as part of a dredging operation. The first separator 108 may include a sieve mat or screen that is operatively coupled to a motion-inducing apparatus. In some cases, a motion-inducing apparatus of the first separator 108 is configured to produce a snapping or oscillatory motion to facilitate separation of the larger objects from the slurry flow.

As shown in FIG. 1, the slurry may be transported from the first separator 108 to subsequent separation devices for removing remaining solids and particulates. In this example, the slurry is transported from the first separator 108 to a second separator 109, where particles having a second size, smaller than the first size, are removed. In some implementations, the second separator 109 includes a hydrocyclone device that is configured to remove sand and gravel-sized particulate from the slurry. The hydrocyclone device may include features for inducing a rotational flow in the slurry that can be used to separate particles of a certain size by centrifugal force. In some embodiments, the second separator 109 may include a settling tank or other device that is configured to remove particles of a particular size.

As shown in FIG. 1, the slurry that is processed by the second separator 109 is transported to a flocculating system 110 that may be configured to flocculate the solids that are suspended in the slurry. In some embodiments, a flocculating agent may be introduced to the slurry at flocculating system 110 to help flocculate the suspended solids. The flocculating agent may encourage or facilitate a flocculation process that results in the bonding of clays, polymers, or other small charged particles to form delicate flocks that may remain suspended in the slurry. Additionally or alternatively, the flocculating system 110 may include an electro-flocculation process that introduces ions or charged particles into the slurry, which may encourage or otherwise facilitate the formation of flocks. In some implementations, flocculation occurs after agitation of the flow ceases and the slurry is a sufficiently quiescent state to allow for the formation of flocks. The flocks may be formed, for example, due to attractions between negative face charges and positive edge charges on solid particles that are suspended in the slurry. Preservation of the floc structure through the subsequent separation processes may be advantageous, in some cases.

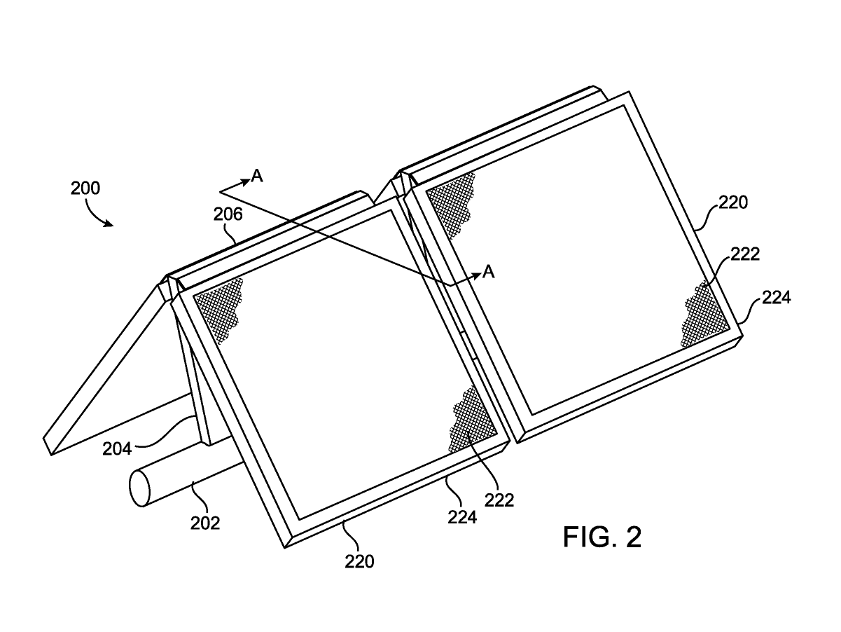

As shown in FIG. 1, the flocculated slurry may be transported or delivered to a third separator 120 that can be used to separate the flocculated solids from the water as part of a dewatering process. In some embodiments, the third separator 120 includes a tracking screen assembly that is configured to remove the flocculated solids from the liquid of the slurry. An example tracking screen assembly is depicted in FIGS. 2-3 and described in more detail below. In some implementations, the third separator 120 include a series of inclined tracking screens or filters that are configured to draw water or liquid away from the flocculated solids as the slurry flows down the inclined tracking screen by gravity. The third separator 120 may be used to collect substantially dewatered flocculated solids, which may be further dewatered to form a dry cake or mass. The third separator 120 may also produce a flow of water that has been separated from the flocculated solids. In some cases, the water produced by the third separator 120 is further processed, returned to the body of water, or is diverted for use in another system.

FIGS. 2 and 3 depict an example tracking screen assembly 200 in accordance with some embodiments. As mentioned above, the tracking screen assembly 200 may be integrated into a comprehensive dredging retrieval and slurry processing operation, as described above with respect to FIG. 1. In particular, the tracking screen assembly 200 may be used as the third separator 120 described above with respect to FIG. 1. However, the tracking screen assembly 200 may also be used to dewater slurries produced from a variety of other types of operations, including, for example, mine tailing processing, oil sand processing, paper manufacturing, and other liquid-based processes.

FIG. 2 depicts a perspective view of an example tracking screen assembly 200 and FIG. 3 depicts a cross-sectional view of the same example tracking screen assembly 200 taken along section A-A. As previously discussed, a tracking screen assembly may be used to separate solids from a slurry as part of a dewatering process or operation. As shown in FIG. 2, the tracking screen assembly 200 includes an array of tracking screen 220 arranged as opposing pairs along the length of the assembly 200. The number of tracking screen pairs may be configurable to adapt the assembly for a particular processing capacity or throughput.

In the example depicted in FIGS. 2-3, the tracking screen assembly 200 is configured to separate flocculated solids from a flow of slurry using a gravity fed mechanical separation process. As shown in FIG. 3, a flow of slurry is delivered to an upper portion of a tracking screen 220 by an outlet 206 of a riser duct 204. In the present embodiment, a single riser duct 204 elevates the flow of slurry and feeds two opposing tracking screens 220 that are arranged on either side of the duct 204. The slurry may transition from the outlet 206 of the riser duct 204 to the tracking screen by a pair of corresponding flow plates 208. The tracking screens 220 are set at an incline angle 6, also referred to as an angle of repose 6. The tracking screens 220 include a screen mesh media 222 that is configured to drain liquid from the solids of the slurry as the flow moves down the inclined surface of the tracking screen 220. The partially dewatered solids may collect on the top surface of the tracking screen 220, while the liquid is allowed to drain through the tracking screen 220 and be collected and diverted to an outlet via a lower duct 226 located under the tracking screen 220. The collected liquid may have a substantial amount of the flocculated solids removed by the tracking screen 220. In some cases, the collected liquid is further filtered or returned to the body of water from which it was collected.

In the example tracking screen assembly 200 of FIGS. 2-3, a flow of flocculated slurry may be delivered to an inlet of the lower feed conduit 202. The lower feed conduit 202 may be constructed from a sheet metal duct or pipe. The lower feed conduit 202 may be connected to a duct or main feed pipe that connects multiple separator stages, described above in the example system of FIG. 1. The flow of flocculated slurry may be provided, in some implementations, from a flocculating station located upstream as part of a larger processing system (e.g., flocculating station 110 of FIG. 1). The flow of flocculated slurry provided to the lower feed conduit 202 may be substantially free of large solids, sands, or non-suspended particulates.

In the example of FIGS. 2-3, the lower feed conduit 202 is coupled to, as well as provides a flow of slurry to, multiple riser ducts 204. The riser ducts 204 may be used to elevate the flow of slurry to a height that is above the upper edge of the tracking screens 220. In the example depicted in FIGS. 2-3, a single riser duct 204 is used to supply a flow of slurry to a pair of tracking screens 220. In some embodiments, a separate riser duct 204 is dedicated to each tracking screen 220. In some embodiments, multiple tracking screens 220 or the entire array of tracking screens 220 are supplied a flow of slurry by a single riser duct 204.

In some implementations, the riser ducts 204 are configured to produce a substantially even flow of flocculated material without causing the flocculated material to precipitate or settle during the elevation process. In some embodiments, the riser ducts are configured to inject or deliver a substantially even distribution of gas bubbles into the flocculated slurry. An injection of gas may prevent or reduce the precipitation of solids, flocs, and other particulate, which may prevent clogging or uneven flow in the riser ducts 204. An injection of gas may also assist in the elevation of the slurry by reducing the density of the flow and also providing a positive lift as the bubbles rise through the duct. An example riser duct using air injection is provided in U.S. Pat. No. 8,678,200 titled “Apparatus and Method for De-watering of Slurries,” which is incorporated by reference into this disclosure, in its entirety.

As shown in FIG. 2-3, the riser ducts 204 are coupled to an outlet 206 that is disposed above an upper edge of the tracking screens 220. In some embodiments, the outlet 206 may be integrally formed into a portion of the riser duct(s) 204. In some embodiments, the outlet 206 is formed as a separate conduit that is operably coupled to the riser ducts 204. In some implementations, the outlet is configured to deliver a substantially even distribution of flow to the tracking screen 220. In cases where a flow of gas is delivered in the riser duct 204, the outlet 206 may also be configured to facilitate the release of gas, which may break the surface of the flow at the outlet 206.

As shown in FIG. 3, the riser ducts 220 are inclined at an angle 6 with respect to a horizontal plane. The angle of the incline may depend, in part, on one or more properties of the slurry, including the ratio of suspended solid to liquid, the type of solid that is suspended, and the flow rate of the slurry. In some implementations, the angle of the incline is 6 adjustable or variable to account for variations in one or more aspects of the flow and allow the tracking screen assembly 120 to be adapted to a variety of applications.

One potential advantage to the dewatering system using a tracking screen assembly 200, as shown in FIGS. 2-3 is that the system can be readily scaled to increase throughput by adding tracking screens to the tracking screen assembly 200 or by operating multiple tracking screen assemblies 200 in parallel or in series. Additionally, within a tracking screen assembly 200, the processing capacity can also be reduced by diverting flow away from one or more of the riser ducts 204 using a valve or fluidic control element. This may allow for service of one or more tracking screens 220 while continuing to dewater slurry using the remaining operating tracking screens.

As shown in FIG. 3, the tracking screen 220 includes a screen mesh media 222 supported by a structural frame 224. At least a portion of the structural frame 224 is formed around the perimeter of the tracking screen and provides structural support for the screen mesh media 222. In one non-limiting example, the screen mesh media 222 is supported by a structural frame 224 that is formed from steel bar members having a 6 mm (¼″) thickness and a 50 mm (2″) width. In some embodiments, the structural frame 224 may also include lateral or cross support members for increasing the rigidity of the tracking screen 220.

In some cases, the screen mesh media 222 includes a wire mesh having apertures formed therein for providing for the free drainage of liquid from the slurry. In one non-limiting example, the aperture is less than 3 mm in width. In another non-limiting example, the aperture is less than 1 mm in width. In another non-limiting example, the aperture is less than 0.5 mm in width. The wire mesh may be specially configured to separate flocculated solids from the liquid in the slurry. In some embodiments, the wire mesh is formed using a wedge-wire construction, which may include wire members that are tapered or beveled to enhance the separation properties of the mesh. In some embodiments, the wedge wires are tapered and also positioned at an angle with respect to the flow of slurry to enhance the solid separating properties of the mesh. In one non-limiting example, the wedge wire extends along the width of the tracking screen 220 and angled at an approximately 5 degree angle toward the flow of the slurry.

In some embodiments, the screen mesh media 222 is formed from an array of wire elements that are arranged substantially horizontal or substantially perpendicular to the flow of slurry as it moves down the tracking screen 220. In some cases, the apertures of the screen mesh media 222 are formed from the openings between the substantially horizontal wire elements. In this case, the width of the aperture represents the distance between horizontal elements of the screen mesh media. In some embodiments, the screen mesh media 222 is formed from two or more arrays of wire elements that are arranged along different orientations. The arrays of wire elements may be interwoven or are otherwise intersecting in nature. In this case, apertures may be formed by the space between intersecting or interwoven arrays of wire elements having an effective width that may represent the narrowest dimension of the opening formed by the wire elements.

In some cases, the screen mesh media 222 may become blocked or blinded by the flocculated material. In particular, the flocks may become wedged or jammed in the apertures of the wire mesh preventing the free drainage of liquid from the slurry. One solution is to use a spray of water to dislodge the flocks and irrigate the flocculated solids. This may be achieved by using one or more spray bars that are located proximate to the upper surface of the tracking screen. While the spray may be effective in dislodging the flocs or trapped solids, the addition of water may, in some cases, be undesirable. In particular, using a water spray requires additional water resources and may also result in a solid mass or product that is more runny or soggy. Moreover, the quality of the solids that are produced using a spray technique may be inconsistent and difficult to stockpile or transport.

Additionally, the water and other liquids may form a film or web within or over surfaces of the screen mesh media, thereby preventing the free drainage of liquid from the slurry. The film may be formed in a variety of locations with respect to the mesh media. In some cases, the film is formed over a portion of the top surface of the screen mesh media. In some cases, the film is formed over a portion of the bottom surface of the screen mesh media. In some cases, a film or web is formed within one or more apertures of the screen mesh media.

The web or film may be formed as a result of the surface tension or surface energy of the liquid being drained. In some cases, the blockage or blinding caused by the surface tension of the liquid may become worse if the slurry includes detergents or surfactants that may further reduce the surface tension of the liquid, which may result in the formation of a blocking film. Additionally, the presence of polymers or other additives in the slurry may also promote film formation or otherwise result in blinding of the screen mesh media.

One solution to improving the free drainage of liquid through the tracking screen is to provide a pulse of energy to the tracking screen. In some embodiments, a pulse or wave of energy is created using a percussion mechanism operatively coupled to the tracking screen. As described in more detail below with respect to FIGS. 3-6, the percussion mechanism may be configured to produce a sudden and momentary displacement of the tracking screen. The displacement may create a wave or pulse of energy that begins at one end of the tracking screen and traverses to an opposite end of the tracking screen. In some embodiments, the pulse of energy propagates across a localized area of the tracking screen that is less than a total area of the tracking screen. The energy pulse may be followed by a rest period in which substantially no energy is delivered to the tracking screen by the percussion mechanism.

In some implementations, the pulse of energy is sufficiently disruptive to break or dislodge liquid that is trapped in the screen mesh media. In some cases, the pulse of energy is sufficiently disruptive to break a film that is formed within or on a surface of the screen mesh media. The amount of energy, and thus the amount of disruption may depend, at least in part, on the amplitude of the displacement and the rate of displacement. The energy pulse may, in some cases, be sufficient to promote the free drainage of liquid from the slurry though the screen mesh media.

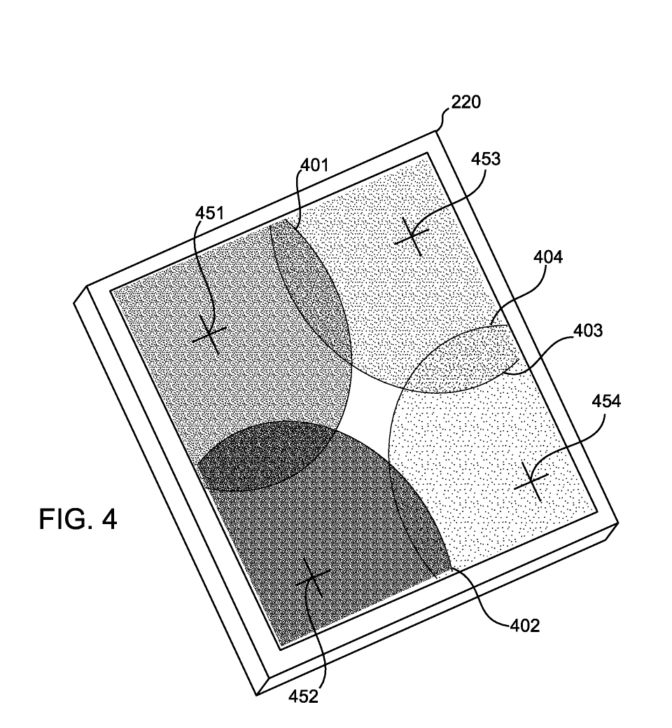

While the pulse of energy may be sufficient to dislodge liquid trapped in the screen mesh media, if the pulse of energy is too large, the structure of the flocs may be destroyed, degraded, collapsed or otherwise broken down due to shear forces within the slurry. Shearing of the floc structures may be undesirable as it may have an adverse effect on the dewatering process. In particular, degradation of the floc structures may increase the amount of solids that pass through the screen mesh media and potentially decrease the efficiency of the dewatering process. For example, the degradation of the floc structures may results in an output of dirty water after passing through the tracking screen. Degraded flocs may more easily pass through the screen mesh media resulting in a liquid output that is brown or cloudy. Therefore, in some cases, it may be advantageous that the energy of the pulse be configured to reduce or prevent substantial degradation or collapse of the floc structure. Additionally, it may be advantageous that there is a rest period between energy pulses in which substantially no energy is delivered to the tracking screen by the percussion mechanism or mechanisms. Additionally, as explained in more detail below with respect to FIG. 4, it may be advantageous to deliver the energy pulses at different times to reduce the amount of energy delivered to a particular portion of the slurry.

In some cases, the pulse of energy causes a gentle shifting of the flocculated solids and helps to release liquid that may be trapped within the flocs of the flocculated mass. Again, it may be beneficial to limit the energy of the pulse to prevent the shearing of the floc structure, but still provide sufficient energy to cause a shifting or movement within a group of floc structures. In some cases, the pulse of energy may facilitate removal of water that is adhered to the surface of the flocs, also referred to as capillary water.

In some implementations, an energy pulse is produced at a regularly repeating interval. A series of energy pulses may facilitate free drainage of the tracking screens as slurry material continues to be introduced as part of an ongoing or continuous operation. In some cases, the energy pulses are delivered at a rate of 5 pulses per minute or greater. In some cases, the energy pulses are delivered at a rate of 120 pulses per minute or less. The pulse rate may depend on various factors, including, for example, the flow rate of the slurry, the size of the tracking screen, the density of the slurry, and the size or structural composition of the flocs or floccules mixed or held in the slurry liquid.

With reference again to FIG. 3, the tracking screen assembly 200 includes multiple percussion mechanisms 251, 252, 255, and 256 located below the lower surface of the tracking screens 220. In the present example, the percussion mechanisms are configured to actuate in a direction that is transverse to the flow of the slurry down the tracking screen 220. In the embodiment depicted in FIG. 3, multiple percussion mechanisms 251, 252 are operable to produce energy pulses for a first (right hand) tracking screen 220. Two additional percussion mechanisms are also disposed relative to the rear surface of the tracking screen 220, but are not visible from the cross-sectional view of FIG. 3. Similarly, multiple percussion mechanisms 255, 256 are operable to produce energy pulses for a second (left hand) tracking screen 220.

In some embodiments, the percussion mechanisms (e.g., 251, 252, 255, 256) each include a fluid-actuated cylinder that is mounted relative to a lower surface of the tracking screen 220. In the present example, the percussion mechanisms are located between the tracking screen 220 and the lower duct 226. The percussion mechanisms may be attached, for example, to a support beam or other structural member located below the lower surface of the tracking screen 220. In some embodiments, the percussion mechanisms are attached to the lower duct 226 using an adaptor plate or support element. In the present example, the percussion mechanism is formed from a fluid-actuated cylinder having a rod end that is configured to deliver an impact to the tracking screen. The rod end may be attached to a plunger, bumper, or other component that is adapted to deliver an impact to the tracking screen 220.

In the present embodiment , the percussion mechanism is a hydraulic cylinder having a piston connected to the actuating rod. When a pulse of hydraulic fluid is delivered to the cylinder, the piston and rod move resulting in a displacement of the tracking screen 220. In some embodiments, the pressure of the hydraulic fluid may range from 10 pounds per square inch (PSI) to 300 PSI. The fluid-actuated cylinder of the percussion mechanism may be a hydraulic-actuated cylinder, a pneumatically actuated cylinder, or other type of fluid-actuated device. In an alternative embodiment, the percussion mechanism may include an electromagnetic, solenoid, or other type of linear actuator. In some embodiments, the percussion mechanism includes a rotating element that may be configured to produce an energy pulse using a linkage or unbalanced rotating mass.

As shown in FIG. 3, the percussion mechanisms 251, 252, 255, 256 are configured to displace the tracking screen 220 in a direction that is substantially perpendicular to a plane of the flow of the slurry on the tracking screen 220. In some cases, a sudden and momentary displacement of the percussion mechanism creates a surface wave in the slurry initiating at the location of the percussion mechanism and propagating across the slurry disposed along the surface of the tracking screen 220. In some implementations, the wave propagates across a localized area of the tracking screen that is less than a total area of the tracking screen 220 and dissipates before reaching an opposite end of the tracking screen 220. In some cases, the energy pulse creates an affected area or drainage zone in which liquid removal from the slurry may be facilitated by the percussion mechanism.

FIG. 4 depicts an example tracking screen 220 operably connected to multiple percussion mechanisms used to produce multiple, partially overlapping drainage zones. In the example depicted in FIG. 4, the tracking screen 220 is operatively connected to four percussion mechanisms that are located proximate to percussion locations 451, 452, 453, 454. Because the percussion mechanisms are located relative to a lower surface of the tracking screen 22, the percussion mechanisms are not visible from the view depicted in FIG. 4. The percussion mechanisms used to deliver an energy pulse at percussion locations 451, 452, 453, 454 may include one or more of: a hydraulic cylinder, a pneumatic cylinder, a linear actuator, a solenoid, a rotating mass, and so on.

As discussed previously, each percussion mechanism may effect a region of the screen that is less than the total area of the tracking screen 220. In the present embodiment, a first percussion mechanism is operable to interface with the tracking screen 220 at a first percussion location 451 to enhance the liquid draining properties over a first drainage zone 401 indicated by the shaded region in FIG. 4. The first drainage zone 401 is a round-shaped region approximately centered about percussion location 451. Similarly, second, third, and fourth percussion mechanisms are operable to interface with the tracking screen 220 at percussion locations 452, 453, and 454, resulting in second 402, third 403, and fourth 404 drainage zones, respectively.

Thus, as shown in FIG. 4, each percussion location 451, 452, 453, 454 results in a separate drainage zone 401, 402, 403, and 404, as indicated by the shaded regions. As also shown in FIG. 4, the drainage zones 401, 402, 403, 404 may partially overlap as indicated by the composite shaded regions in FIG. 4. FIG. 4 also depicts an area near the center of the tracking screen 220 that is not affected by the percussion. The overlap between the drainage zones may be necessary to ensure that a majority or significant portion of the tracking screen 220 receives an energy pulse produced by one of the percussion mechanisms. The location of the percussion mechanisms and the energy pulse that is delivered may be configured to minimize or reduce the amount of overlap between drainage zones.

In some embodiments, the percussion mechanism associated with each drainage zone 401, 402, 403, 404 may be independently actuated. In one example, the percussion mechanisms associated with each percussion location 451, 452, 453, 454 may be actuated separately at different times according to a predetermined actuation sequence. By actuating the percussion mechanisms at different times, the risk of shearing the flocculated solids may be reduced. For example, flocculated solids that are located in the overlap between drainage zones may not be subjected to two energy pulses at the same time, which may result in shearing, degradation, or collapse of the floc structures.

In some embodiments, pairs of percussion mechanisms that do not result in overlapping drainage zones may be actuated or operated together without significantly increasing the risk of floc shear. In the example depicted in FIG. 4, the percussion mechanisms associated with non-overlapping drainage zones 401 and 404 may be operated in tandem. Similarly percussion mechanisms associated with non-overlapping zones 402 and 403 may be operated in tandem and at a different time than the mechanism for drainage zones 401 and 404.

The actuation of the percussion mechanism may also be coordinated with the flow of the slurry as it progresses down the tracking screen 220. For example, a first set of energy pulses may be delivered to the slurry as the slurry flows over an upper region of the tracking screen 220 that roughly corresponds to upper zones 401 and 403. A second set of energy pulses may be delivered the same portion or volume of slurry as it flows through a lower region of the tracking screen 220 that roughly corresponds to the lower zones 402 and 404. The timing between the actuation of the upper zones 401, 403 and the actuation of the lower zones 402, 404 may be dependent, at least in part, on the flow rate or speed in which the slurry travels down the tracking screen 220

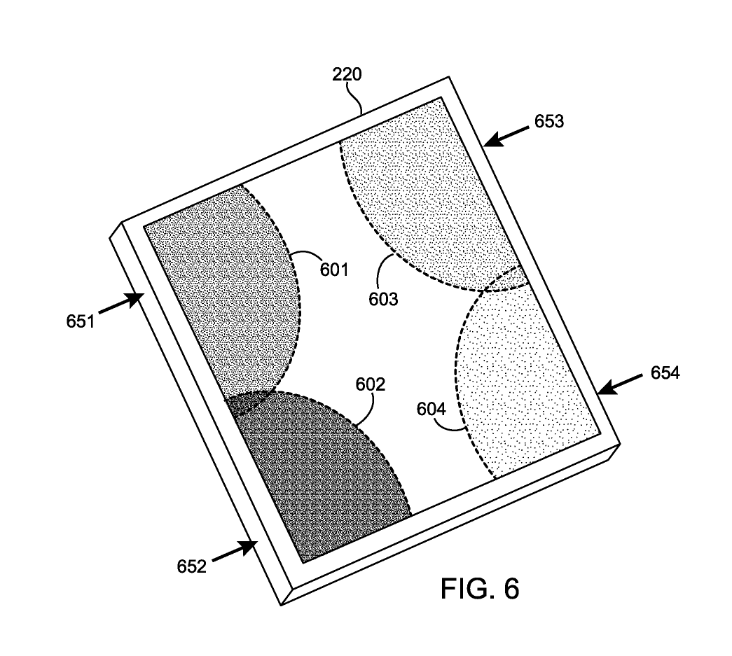

FIGS. 3 and 4 depict one example configuration for providing an energy pulse to a tracking screen using percussion. However, a variety of other configurations may also be used. FIGS. 5 and 6 depict one alternative embodiment for providing energy pulses to a tracking screen. FIG. 5 depicts an example tracking screen 220 having multiple percussion mechanisms 551, 552, 553, 554 that are configured to actuate in a direction that is substantially planar to the direction of the flow. In particular, FIG. 5 depicts a tracking screen 220 operatively coupled to four percussion mechanisms 551, 552, 553, 554 that are configured to displace the tracking screen 220 in a direction that is approximately in plane with, and transverse to, the flow of the slurry down the tracking screen 220. More generally, the percussion mechanisms 551, 552, 553, 554 are configured to displace the tracking screen 220 in a direction that is substantially parallel to the plane of the flow down the tracking screen 220. Similar to the previous example, the percussion mechanisms 551, 552, 553, 554 may include a fluid-actuated cylinder that is configured to cooperate with a surface of the tracking screen 220. The fluid-actuated cylinder may be a hydraulic-actuated cylinder, a pneumatically actuated cylinder, or other type of fluid-actuated device. In an alternative embodiment, one or more of the percussion mechanisms can include an electromagnetic or other type of linear actuator. In some embodiments, one or more of the percussion mechanisms include a rotating element that may be configured to produce an energy pulse using a linkage or unbalanced rotating mass.

FIG. 6 depicts an example tracking screen operably connected to multiple percussion mechanisms to produce multiple, partially overlapping drainage zones. As shown in FIG. 6, multiple percussion mechanisms may be used to deliver an energy pulse a percussion locations 651, 652, 653, 654. The percussion mechanisms that may be used include one or more of: a hydraulic cylinder, a pneumatic cylinder, a linear actuator, a solenoid, a rotating mass, and so on.

As shown in FIG. 6, the percussion mechanism is configured to displace the tracking screen 220 in a direction that is transverse to, and approximately planar with the flow of slurry down the tracking screen 220. In some cases, a sudden and momentary displacement at one of the percussion locations 651, 652, 653, 654 creates a surface wave in the slurry initiating at side of the tracking screen 220 attached to the percussion mechanism 501 and propagating across the slurry disposed along the surface of the tracking screen 220. As shown in FIG. 6, the wave propagates across a localized area of the tracking screen that is less than a total area of the tracking screen 220 and dissipates before reaching an opposite end of the tracking screen 220.

The regions of the tracking screen 220 in which the drainage of the slurry is affected by a corresponding energy pulse may be designated as a drainage zone 601, 602, 603, 604. As shown in FIG. 6, each percussion location 651, 652, 653, 654 may result in a corresponding drainage zone 601, 602, 603, and 604, as indicated by the regions of FIG. 6. As shown in FIG. 6, drainage zone 601 partially overlaps with drainage zone 602, and drainage zone 603 partially overlaps with drainage zone 604. In this example, the energy pulses produced from opposing sides of the tracking screen 220 do not overlap.

As in the previous example, the energy pulses provided at the various percussion locations 651, 652, 653, 654 may delivered independently from one another. In some embodiments, the energy pulses or percussion actuations are provided according to a predetermined order or sequence. As described above, by actuating the percussion mechanisms at different times, the risk of shearing the flocculated solids may be reduced. For example, flocculated solids that are located in the overlap between drainage zones may not be subjected to two energy pulses at the same time, which may result in shearing, degradation, or collapse of the floc structures. Thus, a percussion at location 651, which is effective over drainage zone 601 may be actuated at a different time than a percussion at location 652, which is effective over drainage zone 602, which partially overlaps drainage zone 601. Similar to as described above, the energy pulses produced by the percussions may be configured to correspond to the flow of the slurry to produce multiple energy pulses for a single volume or portion of slurry as it flows down the tracking screen 220.

In the examples of FIGS. 4-6, the tracking screens are operatively coupled to multiple percussion mechanisms. However, in some embodiments, a single percussion mechanism may be operable coupled to a single tracking screen. The location of the percussion mechanism may depend on the area of propagation and dynamics of the tracking screen and/or other supporting structures.

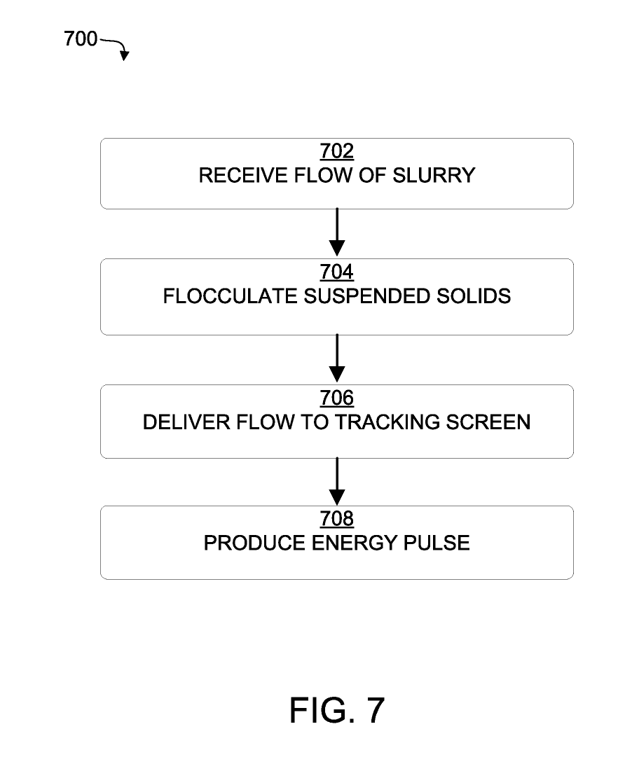

FIG. 7 depicts an example process for separating flocculated solids from a slurry. The example process 700 may be used to separate flocculated solids from the liquid in a slurry using one or more of the embodiments described above with respect to FIGS. 1-6. In particular, the process 700 may be implemented on a single tracking screen of a tracking screen assembly or array of tracking screens. Furthermore, process 700 may be performed using a single percussion mechanism of the tracking screen, independent of other percussion mechanism that may also be operably coupled to the same tracking screen.

In operation 702, a flow of slurry is received at the tracking screen. The flow of slurry may be received from a conduit or pipe that transports the slurry from a collection point or from another upstream processing station. As described previously, the slurry may include a liquid and solid particulate that is suspended in the liquid. The slurry may be received as part of a dredging process, mine tailing retrieval process, paper producing process, or other liquid-based operation. In some implementations, the slurry is substantially free of large objects, gravel, and sand. With reference to FIG. 1, the flow may be received from one or more upstream separators that are configured to remove solids greater than a particular size. In some cases, the solid particulate that is suspended in the liquid of the slurry is less than 1 mm in diameter. In some cases, the solid particulate is less than a micron in size. In some cases, the solid particulate is less than several angstroms in size.

In operation 704, at least a portion of the solid particulate is flocculated to form the flocculated slurry. The flocculated slurry includes the flocculated material substantially in suspension in the liquid. In one embodiment of operation 704, a flocculating agent is added to the slurry. The flocculating agent may encourage or facilitate a flocculation process that results in the bonding of clays, polymers, or other small charged particles to form delicate flocks within the slurry. In some embodiments, an electro-flocculation process is used to introduce ions or charged particles into the slurry, which may encourage or otherwise facilitate the formation of flocks. In some implementations of operation 704, the flocculation occurs after agitation of the flow ceases and the slurry is a sufficiently quiescent state to allow for the formation of flocks. The flocks may be formed, for example, due to attractions between negative (anionic) face charges and neutral or positive (cationic) edge charges on solid particles that are suspended in the slurry.

The size of the flocs produced in operation 704 may range in size from approximately 7 angstroms to approximately 5 microns in size. The size and structure of the flocs may depend on the type of solid that is suspended in the slurry liquid and also the parameters and agents used in the flocculation process of operation 704. As previously mentioned, preservation of the floc structure may be important to an efficient dewatering operation. Thus, as described below, it may be beneficial that the energy pulses that are delivered to the slurry do not shear, degrade, collapse or otherwise break down the delicate structure of the flocs.

In some implementations of process 700, operation 704 is optional. In one example, the flocculated material had already been formed before process 700 had begun. In this case, the slurry that is received in operation 702 already includes a substantial amount of flocculated material and, therefore operation 704 may not be necessary. In another example, the slurry is processed without flocculating the suspended particulates. That is, in some cases, the dewatering process is performed on the suspended particulates, without forming flocs or other structures within the slurry.

In operation 706, a flow of the flocculated slurry is delivered to a tracking screen. With reference to FIGS. 2-3, the flow may be delivered using, for example, a riser duct 204 and an outlet 206 that are disposed proximate to an upper end of the tracking screen. In accordance with the previous examples, the tracking screen may be positioned on an incline and configured to separate the flocculated material from the liquid as the slurry passes over the screen. In particular, the liquid of the slurry may be allowed to drain by gravity through a screen mesh media of the tracking screen, while the solids remain on an upper surface. The separated liquid may be collected from below the tracking screen (e.g., using lower duct 226 of FIG. 3) and the solids may slide down or otherwise be removed from the upper surface of the tracking screen. The separated liquid may be substantially free of flocculated solids and may be further filtered, stored, or returned to main a body of water. The separated flocculated solids may also be transferred to another station or system to further dewater or extract any remaining liquid.

With respect to operation 706, in some embodiments, it may be advantageous that the flow of slurry be delivered or distributed as a substantially even flow to upper surface of the tracking screen. In particular, it may be advantageous that the flow have a substantially even flow rate and density. Additionally, it may be advantageous that the flow be substantially evenly distributed across an upper portion of the tracking screen. In particular, it may be advantageous that the riser and outlet used to deliver the slurry may be configured to produce a flow of slurry that has substantially uniform flow characteristics across the upper portion of the tracking screen where the slurry is being delivered. In accordance with the example provided above with respect to FIGS. 2-3, the riser duct may include a gas injection system that is configured to produce a substantially even distribution of bubbles within the riser duct that may facilitate both a substantially even flow and a substantially even distribution to the tracking screen.

In operation 708, while the flow of flocculated slurry is disposed relative to the tracking screen, a pulse of energy is delivered to the tracking screen. In particular, a percussion mechanism may be used to generate a pulse of energy or a wave that propagates across the tracking screen. In some embodiments, the percussion mechanism is configured to produce a single, momentary displacement of the tracking screen to generate the energy pulse. The displacement may be caused, for example, by a linear actuator in accordance with the examples provided above with respect to FIGS. 3-6.

As previously discussed, it may be advantageous that the pulse of energy is sufficiently disruptive to break or dislodge liquid that is trapped in the screen mesh media. In some cases, the pulse of energy is sufficiently disruptive to break a film that is formed within or on a surface of the screen mesh media and to allow for the free drainage of liquid from the slurry though the screen mesh media. Additionally, while the pulse of energy may be sufficient to dislodge liquid trapped in the screen mesh media, it may be further advantageous that the energy of the pulse be limited to prevent degradation or collapse of the floc structures. Furthermore, the pulse of energy may cause a gentle shifting of the flocculated solids and helps to release liquid that may be trapped within a flocculated mass. Thus, in some cases, the pulse of energy may facilitate removal of water that is adhered to the surface of the flocculated structures, otherwise referred to as capillary water or liquid. Furthermore, the pulse of energy may also facilitate the movement of the dewatered solids down the tracking screen where they may be collected and/or removed.

In some aspects of operation 708, the pulse of energy is delivered at a regularly repeating interval. In some implementations, a pulse of energy is delivered at a rate of 5 pulses per minute or more. In some implementations, a pulse of energy is delivered at a rate of 120 pulses per minute or less. As described above with respect to FIGS. 4 and 6, the pulse of energy may have an effective area that is less than the entire area of the tracking screen. In some embodiments, the pulse of energy results in improved liquid drainage over a portion of the tracking screen that is referred to herein as a drainage zone. As discussed above, multiple percussion mechanisms may be arranged to provide a series of partially overlapping drainage zones. The percussion mechanisms may be independently actuated according to a predetermined order or actuation sequence.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

We claim:

1. A method for dewatering a flocculated slurry:
receiving a flow of slurry comprising a liquid and solid particulate that is suspended in the liquid;
flocculating at least a portion of the solid particulate to form the flocculated slurry comprising flocculated material and the liquid;
delivering a flow of the flocculated slurry to a tracking screen configured to separate the flocculated material from the liquid; and
while the flow of flocculated slurry is disposed relative to the tracking screen, delivering a pulse of energy to the tracking screen.

2. The method of claim 1, wherein the pulse of energy is produced using a percussion mechanism that is operatively coupled to the tracking screen.

3. The method of claim 2, wherein the percussion mechanism is used to deliver a series of energy pulses at a rate greater than 5 pulses per minute and less than 120 pulses per minute.

4. The method of claim 3, wherein the series of energy pulses includes a rest period between energy pulses in which substantially no energy is delivered to the tracking screen by the percussion mechanism.

5. The method of claim 1, wherein the pulse of energy is delivered to the flow of flocculated slurry via the tracking screen to produce a drainage zone that corresponds to a portion of the tracking screen having improved liquid drainage.

6. The method of claim 1, wherein:
a first pulse of energy is produced using a first percussion mechanism that is operatively coupled to the tracking screen resulting in a first drainage zone;
a second pulse of energy is produced using a second percussion mechanism that is operative coupled to the tracking screen resulting in a second drainage zone; and
the first drainage zone and the second drainage zone are partially overlapping.

7. The method of claim 6, wherein the first pulse of energy and the second pulse of energy are delivered to the tracking screen at different times.

8. The method of claim 1, wherein:
a first pulse of energy is produced using a first percussion mechanism that is operatively coupled to the tracking screen resulting in a first drainage zone;
a second pulse of energy is produced using a second percussion mechanism that is operative coupled to the tracking screen resulting in a second drainage zone; and
the first pulse of energy and the second pulse of energy are delivered to the tracking screen at different times.

9. The method of claim 1, wherein:
a first pulse of energy is produced using a first percussion mechanism that is operatively coupled to the tracking screen resulting in a first drainage zone:
a second pulse of energy is produced using a second percussion mechanism that is operative coupled to the tracking screen resulting in a second drainage zone; and
a third pulse of energy is produced using a third percussion mechanism that is operative coupled to the tracking screen resulting in a third drainage zone.

10. The method of claim 1, wherein the pulse of energy causes a disruption in a film of liquid formed on a surface of the tracking screen resulting in an increase of a flow of liquid through the tracking screen.

11. The method of claim 1, wherein the pulse of energy does not substantially degrade floc structures of the flocculated material.

12. The method of claim 1, further comprising:
collecting liquid that passes through the tracking screen, the liquid having a substantial amount of flocculated solids removed by the tracking screen.

13. The method of claim 1, further comprising:
producing a mass of substantially dewatered solids on a top surface of the tracking screen; and
removing the dewatered solids from the top surface of the tracking screen.

14. A method for dewatering a flocculated slurry:
receiving a flow of flocculated slurry comprising flocculated solids in a liquid;
delivering the flow of the flocculated slurry to a tracking screen configured to separate the flocculated solids from the liquid; and
while the flow of flocculated slurry is disposed relative to the tracking screen, delivering a pulse of energy to the tracking screen.

15. The method of claim 14, wherein the pulse of energy is produced using a percussion mechanism that displaces the tracking screen in a direction that is transverse to the flow.

16. The method of claim 14, wherein the pulse of energy is produced using a percussion mechanism that displaces the tracking screen in a direction that is substantially parallel with a plane of the flow.

17. The method of claim 14, further comprising:
before delivering the flow of the flocculated slurry to the tracking screen, elevating the flocculated slurry using a riser duct, wherein a gas is delivered to the riser duct to produce a substantially even distribution of gas bubbles that reduces a precipitation of solids in the flocculated slurry.

18. A tracking screen assembly comprising:
a riser duct configured to receive a flow of flocculated slurry comprising a flocculated solid in a liquid;
an outlet coupled to the riser duct, the outlet configured to distribute the flocculated slurry over a tracking screen;
the tracking screen disposed below the outlet and configured to separate the flocculated solid from the liquid; and
a percussion mechanism operably coupled to the tracking screen and configured to produce an energy pulse to the flow of slurry while the flow of slurry is disposed relative to a surface of the tracking screen.

19. The tracking screen assembly of claim 18, wherein the tracking screen is positioned at an incline angle and is configured to separate the flocculated solid from the liquid as the flocculated slurry is fed by gravity.

20. The tracking screen assembly of claim 18, wherein the riser duct is configured to deliver a substantially even distribution of gas bubbles into the flocculated slurry.

21. The dewatering apparatus of claim 18, wherein the riser duct is operatively coupled to a dredge assembly that is configured to collect solids from a body of water.

22. The dewatering apparatus of claim 18, wherein the riser duct is operatively coupled to a flocculating system that is configured to flocculate solids that are suspended in the liquid of the slurry.
